(19) United States
(12) Patent Application Publication
(10) Pub. No.: US 2025/0097364 A1
(43) Pub. Date: Mar. 20, 2025

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: Kohei Sonoda, Kanagawa (JP)

(21) Appl. No.: 18/882,089

(22) Filed: Sep. 11, 2024

(30) Foreign Application Priority Data
Sep. 19, 2023 (JP) 2023-150944

(51) Int. Cl. H04N 1/32; G06F 3/12

(52) U.S. Cl. CPC H04N 1/32096; G06F 3/1222; G06F 3/1232; G06F 3/1238

(57) ABSTRACT

A control method of an information processing apparatus includes: checking information on an apparatus model of a communication apparatus that is a transmission destination of a job; determining whether or not predetermined authentication is necessary for the communication apparatus, based on a case where the information on the apparatus model of the communication apparatus is checked to be information corresponding to a first apparatus model; executing processing for the predetermined authentication based on a case where the predetermined authentication is determined to be necessary for the communication apparatus; executing the processing for the predetermined authentication irrespective of whether or not the predetermined authentication is necessary for the communication apparatus, based on a case where the information on the apparatus model of the communication apparatus is checked to be information corresponding to a second apparatus model different from the first apparatus model; and transmitting the job to the communication apparatus.

### BACKGROUND OF THE INVENTION

### Field of the Invention

The present disclosure relates to a technique of transmitting a job from an information processing apparatus to an image forming apparatus.

### Description of the Related Art

In recent years, a high-performance mobile terminal called smartphone is widely used. Moreover, the mobile terminal provides a scan function, a print function, and the like in cooperation with an image forming apparatus, as functions of the mobile terminal. For example, in execution of a function of transmitting a scanned original to a designated address, the mobile terminal searches for the image forming apparatus on a LAN. The mobile terminal generates a transmission job by using a transmission destination mail address and various pieces of scan setting information (for example, color and duplex printing and like) set by a user. Then, the mobile terminal transmits the generated transmission job to the image forming apparatus with the transmission function found by the searching. This allows the user to give an instruction to execute a series of processes of the image forming apparatus necessary for transmission, from the mobile terminal. Specifically, although actual scan processing or print processing is performed in the image forming apparatus, the execution instruction including various settings and the like can be made from the mobile terminal.

Japanese Patent Laid-Open No. 2016-197379 discloses a technique as follows. In the case where a mobile terminal detects that it is approaching an image forming apparatus, the mobile terminal obtains information on whether authentication is necessary to perform a cooperative operation with the image forming apparatus. Then, in the case where the authentication is necessary, a message asking the user whether to execute the authentication or not is displayed on a screen of the mobile terminal. Japanese Patent Laid-Open No. 2016-197379 is a technique based on assumption that the mobile terminal can obtain information on whether or not the authentication is necessary to cooperate with the image forming apparatus, from the image forming apparatus.

There is a demand for a technique that allows appropriate switching of processing depending on whether or not authentication is necessary in the image forming apparatus.

### SUMMARY OF THE INVENTION

A control method of an information processing apparatus according to one aspect of the present disclosure includes: checking information on an apparatus model of a communication apparatus that is a transmission destination of a job; determining whether or not predetermined authentication relating to the job to be transmitted to the communication apparatus is necessary for the communication apparatus, based on a case where the information on the apparatus model of the communication apparatus is checked to be information corresponding to a first apparatus model; executing processing for the predetermined authentication based on a case where the predetermined authentication is determined to be necessary for the communication apparatus; executing the processing for the predetermined authentication irrespective of whether or not the predetermined authentication is necessary for the communication apparatus, based on a case where the information on the apparatus model of the communication apparatus is checked to be information corresponding to a second apparatus model different from the first apparatus model; and transmitting the job to the communication apparatus.

Further features of the present invention will become apparent from the following description of exemplary embodiments with reference to the attached drawings.

### BRIEF DESCRIPTION OF THE DRAWINGS

FIG. 1 is a diagram illustrating an example of an information processing system configuration;

FIG. 2 is a diagram illustrating an example of a hardware configuration of an information processing apparatus;

FIG. 3 is a block diagram illustrating an example of a hardware configuration of an image forming apparatus;

FIG. 4 is a diagram illustrating an example of a software configuration of the image processing apparatus;

FIG. 5 is a diagram illustrating an example of a software configuration of the image forming apparatus;

FIGS. 6A and 6B are diagrams illustrating display screens of an application operating on the information processing apparatus;

FIGS. 7A and 7B are diagrams illustrating display screens of the application operating on the information processing apparatus;

FIG. 8 is a diagram showing the relationship of FIGS. 8A and 8B.

FIGS. 8A and 8B are totally a flowchart illustrating an example of control processing relating to authentication;

FIGS. 9A and 9B are diagrams illustrating display screens of the application operating on the information processing apparatus; and

FIG. 10 is a diagram showing the relationship of FIGS. 10A and 10B.

FIGS. 10A and 10B are totally a flowchart illustrating an example of control processing relating to authentication.

### DESCRIPTION OF THE EMBODIMENTS

Preferable embodiments of the present disclosure are explained below in detail with reference to the drawings. Note that the following embodiments do not limit the matters of the present disclosure, and not all of combinations of characteristics explained in the following embodiments are necessarily essential for solving means of the present disclosure. Note that the same constituent elements are denoted by the same reference numerals.

### First Embodiment

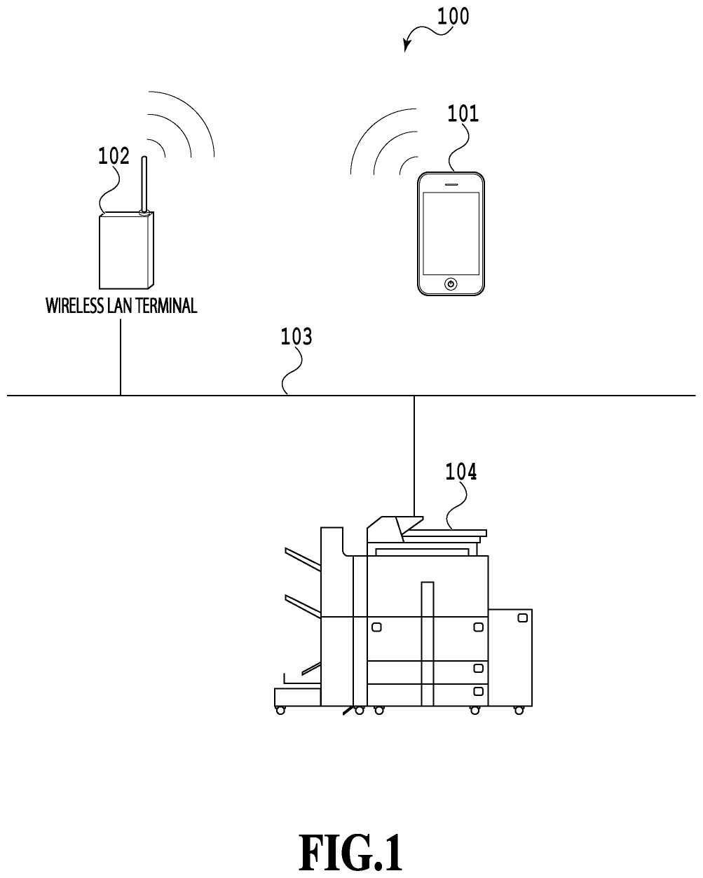

FIG. 1 is a diagram illustrating an example of an information processing system configuration according to the present embodiment. An information processing system 100 includes an information processing apparatus 101, a wireless LAN terminal 102, and an image forming apparatus 104. These apparatuses are connected to one another via a network 103 such as a local area network (LAN). Apparatuses other than those described herein may be connected to the network 103.

The information processing apparatus 101 is a mobile terminal such as a smartphone or a tablet. An operating system for a small terminal and programs for controlling voice call, position detection, and data communication may operate in the information processing apparatus 101. Alternatively, the information processing apparatus 101 may be a personal computer (PC) that includes no audio control, position detection control, mobile phone data communication, or the like. The information processing apparatus 101 is connected to the network 103 by the wireless LAN terminal 102.

The wireless LAN terminal 102 is a parent station of wireless LAN with a general network router function, and provides wireless network communication by wireless LAN in home, office, or the like.

The image forming apparatus 104 is a digital multifunction peripheral including various job execution functions such as a printer function, a copy function, a scanner function, and a facsimile transmission function. However, the image forming apparatus 104 is not limited to this, and may be an apparatus with a single function. The image forming apparatus 104 may be configured to internally include a wireless access point, and be configured to be capable of directly communicating with the information processing apparatus 101 without the wireless LAN terminal 102. A user can operate the information processing apparatus 101 to give instructions of job execution to the image forming apparatus 104 and output the instructions for executing the various functions of the image forming apparatus 104 through the information processing apparatus 101.

Note that, in the present embodiment, the image forming apparatus 104 is assumed to be in a form in which the image forming apparatus 104 is connected to network 103 by wire. However, the image forming apparatus 104 may be wirelessly connected by using the wireless LAN terminal 102 like the information processing apparatus 101. Moreover, the information processing apparatus 101 and the image forming apparatus 104 are capable of performing short-range wireless communication using wireless signals of near field communication (NFC), Bluetooth Low Energy (BLE), or the like. The image forming apparatus 104 has connection information (IP address, MAC address, or the like) for wireless LAN connection with the image forming apparatus 104, and can transmit the connection information to the information processing apparatus 101 via an NFC communication unit or a BLE communication unit to be described later. The information processing apparatus 101 can start wireless LAN communication with the image forming apparatus 104 by using the obtained connection information.

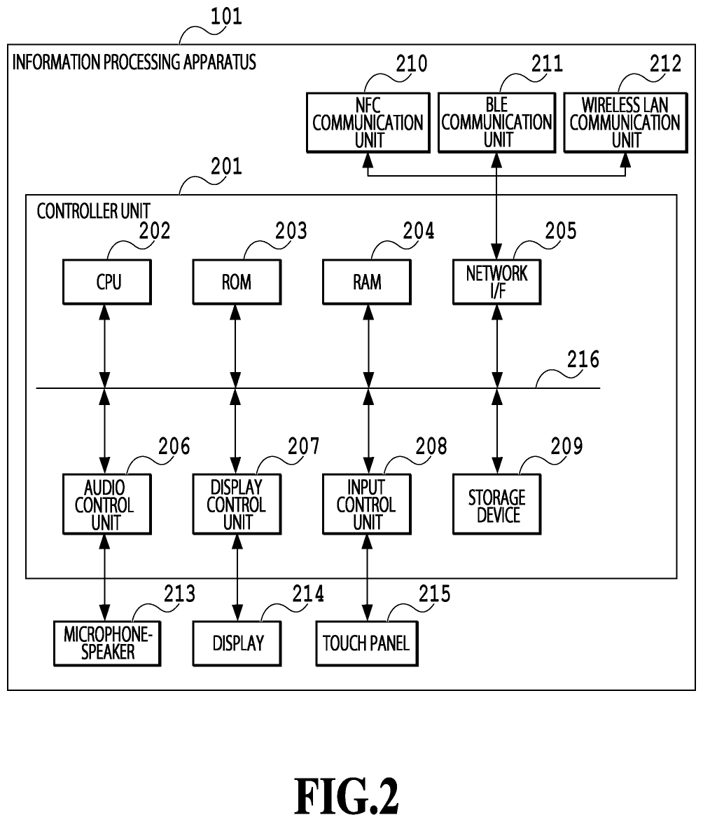

FIG. 2 is a diagram illustrating an example of a hardware configuration of the information processing apparatus 101 according to the present embodiment. The information processing apparatus 101 includes a controller unit 201, an NFC communication unit 210, a BLE communication unit 211, a wireless LAN communication unit 212, a microphone-speaker 213, a display 214, and a touch panel 215. The controller unit 201 controls the various communications units that are the NFC communication unit 210, the BLE communication unit 211, and the wireless LAN communication unit 212 and the various UI units that are the microphone-speaker 213, the display 214, and the touch panel 215.

The controller unit 201 includes a CPU 202, a ROM 203, a RAM 204, a network I/F 205, an audio control unit 206, a display control unit 207, an input control unit 208, and a storage device 209. The configurations of the controller unit 201 are connected to one another by a system bus 216.

The CPU 202 controls an entire system of the information processing apparatus 101. The operating system of the information processing apparatus 101 and the programs for controlling call and data communication are stored in the ROM 203. The CPU 202 executes these various programs. The RAM 204 is used as a main memory of the CPU 202, and is used as a temporary storage area such as a work area. The storage device 209 is a non-volatile storage device, and records various operation mode settings, an operation log, and the like that need to be held also after reactivation of the information processing apparatus 101.

The network I/F 205 are connected to the NFC communication unit 210, the BLE communication unit 211, and the wireless LAN communication unit 212, and exchanges data with the image forming apparatus 104 by various types of wireless communication.

The audio control unit 206 performs input-output control of audio data via the microphone-speaker 213. The display control unit 207 performs output control of image data to be displayed on the display 214. The input control unit 208 performs input control of information for which the user has given an instruction via a button or the touch panel 215. Various applications executed by the information processing apparatus 101 use the audio control unit 206, the display control unit 207, the input control unit 208, and the like.

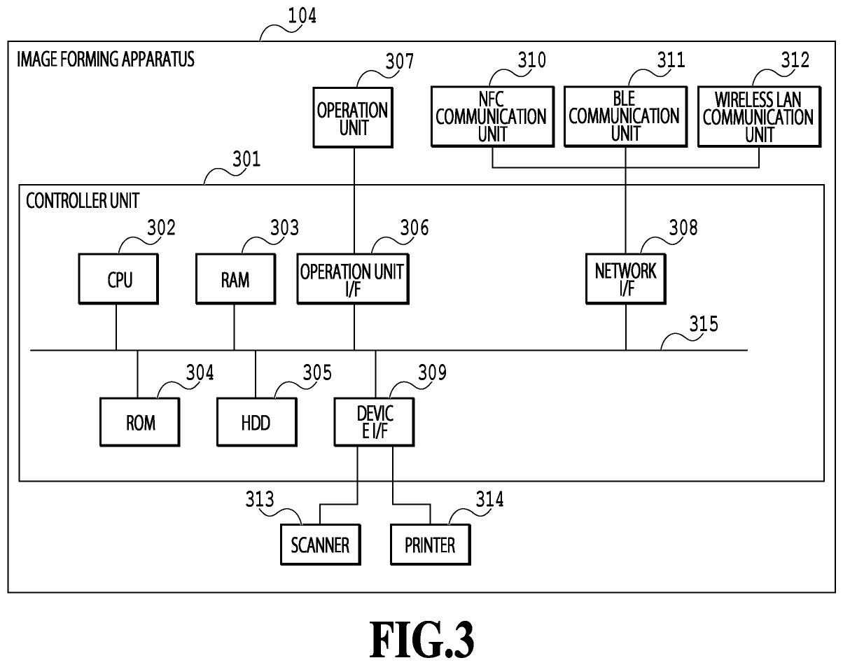

FIG. 3 is a block diagram illustrating an example of a hardware configuration of the image forming apparatus 104 according to the present embodiment. The image forming apparatus 104 includes a controller unit 301, an operation unit 307, an NFC communication unit 310, a BLE communication unit 311, a wireless LAN communication unit 312, a scanner 313, and a printer 314. The controller unit 301 controls the various communication units that are the NFC communication unit 310, the BLE communication unit 311, and the wireless LAN communication unit 312 as well as the operation unit 307, the scanner 313, and the printer 314.

In the case where the user uses the copy function of the image forming apparatus 104, the controller unit 301 obtains image data of an original by controlling the scanner 313, and prints and outputs an image to a sheet by controlling the printer 314. Moreover, in the case where the user uses a “scan and transmit” function, the controller unit 301 obtains image data of an original by controlling the scanner 313, and converts the image data to code data. Then, the controller unit 301 transmits the converted data to the information processing apparatus 101 or the like via a network I/F 308. Furthermore, in the case where the user uses the print function, the controller unit 301 receives the image data (code data) from the information processing apparatus 101 via the network I/F 308. Then, the controller unit 301 transmits the received image data to the printer 314. The printer 314 prints and outputs an image to a sheet based on the received image data. Furthermore, the image forming apparatus 104 has a FAX reception function of receiving data from ISDN or the like and printing the data and a FAX transmission function of transmitting scanned data to ISDN or the like. Processing target work for which the user has performed setting or the like to execute each of functions like those described above is referred to as job. The image forming apparatus 104 executes a predetermined job according to information including the job (referred to as job information).

The controller unit 301 includes a CPU 302, a RAM 303, a ROM 304, an HDD 305, an operation unit I/F 306, the network I/F 308, and a device I/F 309. The configurations included in the controller unit 301 are connected to one another by a system bus 315.

The CPU 302 controls the entire system of the image forming apparatus 104. The RAM 303 is a system work memory for operation of the CPU 302, and temporarily stores the image data and the like. The RAM 303 stores the scan image data read by the scanner 313 and the print image data received from the information processing apparatus 101 via the network 103. The ROM 304 stores a boot program of a system, applications, and the like. The hard disk drive (HDD) 305 stores an operating system, system software, application software, the image data, setting data, and the like.

The operation unit 307 displays information to the user, and receives operations from the user. For example, an operation panel such as a touch panel display is used as the operation unit 307.

The operation unit I/F 306 outputs information to be displayed on the operation unit 307, to the operation unit 307. Moreover, the operation unit I/F 306 receives information inputted by the user, from the operation unit 307. The network I/F 308 is connected to the NFC communication unit 310, the BLE communication unit 311, and the wireless LAN communication unit 312, and exchanges information with the information processing apparatus 101 and a cloud server (not illustrated) by various types of communication. The wireless LAN communication unit 312 performs wireless LAN communication with the information processing apparatus 101 via the network 103. The NFC communication unit 310 and the BLE communication unit 311 each perform short-range wireless communication with the information processing apparatus 101. The image forming apparatus 104 receives the job information including job setting information, the image data, a job execution command, and the like from the information processing apparatus 101 via the network I/F 308, and executes the job. The device I/F 309 connects the controller unit 301 to the scanner 313 that executes reading of the image data and the printer 314 that executes printing, and performs input and output of the image data.

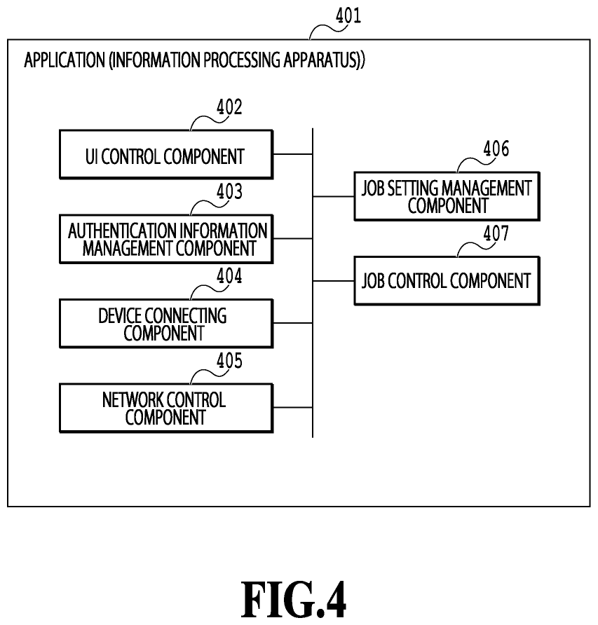

FIG. 4 is a diagram illustrating an example of a software configuration of the information processing apparatus 101 according to the present embodiment. FIG. 4 is a functional block diagram of software implemented by causing the CPU 202 of the information processing apparatus 101 to read a control program (application) stored in the ROM 203 or the storage device 209.

An application 401 is an application installed in the information processing apparatus 101, and is an application for causing the image forming apparatus 104 to operate. The user performs setting on the application 401, and inputs an instruction that causes the application 401 to generate print job information, scan job information, or the like. The application 401 generates the job information according to this instruction. The application 401 can transmit the generated job information to the image forming apparatus 104. Although, various applications other than the application 401 are installed in the information processing apparatus 101, explanation thereof is omitted. A configuration of the application 401 is described below.

The application 401 includes a user interface (UI) control component 402, an authentication information management component 403, a device connecting component 404, a network control component 405, a job setting management component 406, and a job control component 407.

The UI control component 402 receives the job setting information inputted by the user on the touch panel 215, and transmits the received contents to the job setting management component 406 or the job control component 407 via the input control unit 208. The UI control component 402 receives a response from the job setting management component 406 or the job control component 407, and outputs a screen corresponding to the received contents to the display 214 via the display control unit 207. The UI control component 402 receives authentication information inputted by the user on the touch panel 215, and transmits the authentication information to the authentication information management component 403 via the input control unit 208.

The authentication information management component 403 saves and manages the authentication information such as user information received from the UI control component 402. Then, processing of logging into the image forming apparatus 104 is performed based on the saved authentication information. Specifically, the authentication information management component 403 passes the authentication information to the network control component 405. The authentication information is transmitted to the image forming apparatus 104 via the network 103. The image forming apparatus 104 performs login processing by using the received authentication information, and sends back a result to the information processing apparatus 101. The authentication information saved and managed in the image forming apparatus 104 may be given by the application 401 in the transmission of the job information by the application 401 as described above.

The device connecting component 404 establishes short-range wireless communication using, for example, NFC or BLE between the information processing apparatus 101 and the image forming apparatus 104 or wireless LAN communication via the network 103. For example, in the case of NFC, the user brings the NFC communication unit 210 of the information processing apparatus 101 close to the NFC communication unit 310 of the image forming apparatus 104, and this starts the short-range wireless communication. In the case of BLE, the BLE communication unit 311 of the image forming apparatus 104 transmits a BLE beacon, and the BLE communication unit 211 of the information processing apparatus 101 receives the transmitted beacon. In the case where the user brings the information processing apparatus 101 close to the image forming apparatus 104 and this causes the information processing apparatus 101 to determine that a radio field strength of the received beacon has reached or exceeded a certain level, the short-range wireless communication is started. As described above, the user brings the NFC or BLE communication units of the information processing apparatus 101 and the image forming apparatus 104 close to each other to cause the device connecting component 404 to perform the short-range wireless communication with the image forming apparatus 104. Then, the device connecting component 404 obtains device information including connection information necessary for the wireless LAN communication from the image forming apparatus 104 through the short-range wireless communication. For example, the connection information includes, in addition to the IP address, the MAC address, and the like as described above, information such as an SSID and passkey of the wireless LAN to which the image forming apparatus 104 is connected. The device connecting component 404 can start the wireless LAN communication with the image forming apparatus 104 via the network 103 by using the connection information obtained as described above. Note that the method of obtaining the connection information explained above is merely an example, and is not limited to the above method. For example, the device connecting component 404 may achieve the wireless LAN connection with the image forming apparatus 104 by using the connection information inputted by the user via the touch panel 215.

The network control component 405 transmits the job information (information including the job setting information, the job execution instruction command, the image data, the user authentication information, and the like) to the image forming apparatus 104 via the network 103. In the present embodiment, the job information is assumed to be transmitted to the image forming apparatus 104 via the wireless LAN terminal 102. For example, in the case where the transmitted job information is job information for transmitting scanned image data to a set address, the job setting information is information such as settings relating to scanning and the address to which the data is to be transmitted. The network control component 405 can also receive the job setting information or the like stored in the image forming apparatus 104 via the network 103.

The job setting management component 406 stores the job setting information received by the UI control component 402 and inputted by the user and the job setting information received from the image forming apparatus 104 via the network control component 405, in the RAM 204 or the storage device 209. The job setting management component 406 may register these pieces of job setting information in “favorite” as settings frequently used by the user. Moreover, the job setting management component 406 may register the job setting information stored in the RAM 204 or the storage device 209 in installing of the application 401 as “preset”.

The job control component 407 controls processing executed in the image forming apparatus 104. For example, the job control component 407 generates the job information from the job setting information included in the “favorite” or “preset” registered in the job setting management component 406 or the job setting information set by the user operation. Then, the job control component 407 transmits the generated job information to the image forming apparatus 104 via the network 103 to transmit the job execution instruction to the image forming apparatus 104. Moreover, the job control component 407 obtains a job execution status or an operation state of a device of the scanner 313 or the printer 314 from the image forming apparatus 104 via the network 103, and transmits the job execution status or the operation state to the UI control component 402.

As described above, the application 401 can generate the job information and transmit the generated job information to the image forming apparatus 104. In this case, assume that, as the image forming apparatus 104 of the present embodiment, there are a first image forming apparatus with a first platform and a second image forming apparatus with a second platform. The platform may include, for example, both of a software platform and a hardware platform. The first platform is a platform on which the application 401 can obtain authentication necessary-unnecessary information. The second platform is a platform on which the application 401 cannot obtain the authentication necessary-unnecessary information. The authentication necessary-unnecessary information is information indicating whether the authentication information is necessary or unnecessary in the image forming apparatus 104 in the case where the application 401 transmits the job information to the image forming apparatus 104.

In the case where the image forming apparatus 104 to which the application 401 is connected is the first image forming apparatus, the application 401 can obtain the authentication necessary-unnecessary information from the image forming apparatus 104. Accordingly, processing according to the job information is performed in the image forming apparatus 104 in the case where the application 401 transmits the job information to the image forming apparatus 104 according to a mode indicated by the obtained authentication necessary-unnecessary information. For example, in the case where the obtained authentication necessary-unnecessary information is information indicating that authentication is necessary, the application 401 transmits the job information including the authentication information to the image forming apparatus 104. Meanwhile, in the case where the obtained authentication necessary-unnecessary information is information indicating that authentication is unnecessary, the application 401 transmits the job information including no authentication information to the image forming apparatus 104.

Meanwhile, in the case where the image forming apparatus 104 to which the application 401 is connected is the second image forming apparatus, the application 401 cannot obtain the authentication necessary-unnecessary information from the image forming apparatus 104. Accordingly, this general type of application cannot determine whether the authentication information is necessary or unnecessary in the transmission of the job information, and cannot perform switching of processing of whether to add the authentication information or not. Explanation is given of an example in which the application 401 of the present embodiment appropriately performs the processing also in the case where the second image forming apparatus as described above is included in the information processing system.

The authentication information management component 403 of the application 401 is assumed to manage authentication information for the first platform and authentication information for the second platform. Moreover, the authentication information for the first platform can be set by the user on the application 401. This is because it is assumed that the application 401 can obtain the authentication necessary-unnecessary information from the first image forming apparatus of the first platform and that the authentication information for the first image forming apparatus is used on the application 401. Meanwhile, the authentication information for the second platform cannot be set by the user on the application 401. This is due to the following reason. Since the authentication necessary-unnecessary information cannot be obtained from the second image forming apparatus, the user may be confused if the user is allowed to set the authentication information for such a platform on the application 401. Note that the authentication information for the second platform is configured to be set by internal processing of the application 401 as described later.

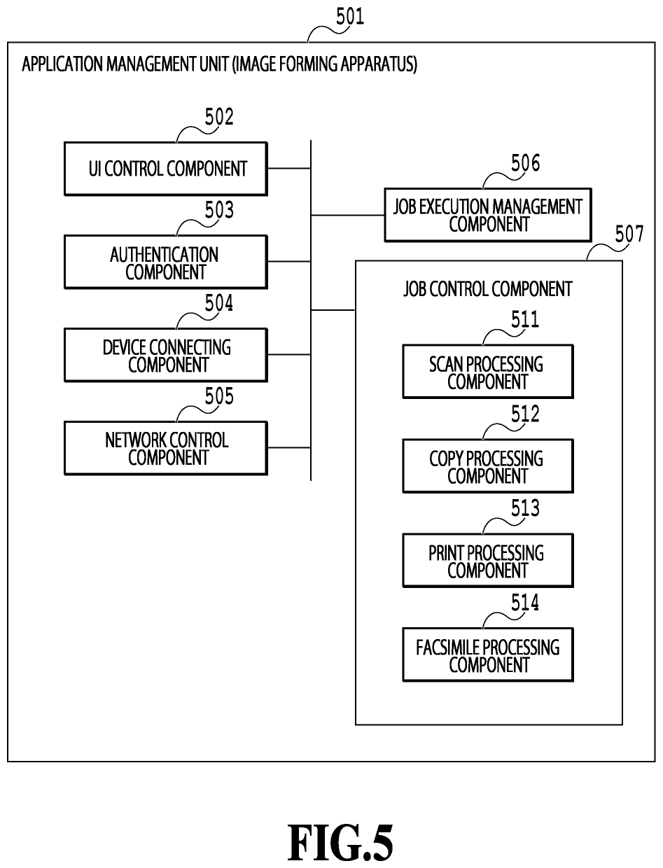

FIG. 5 is a diagram illustrating an example of a software configuration of the image forming apparatus 104 according to the present embodiment. FIG. 5 is a functional block diagram of software implemented by causing the CPU 302 to read a control program stored in the ROM 304 or the HDD 305.

An application management unit 501 manages an application that operates on the image forming apparatus 104. The application management unit 501 includes a user interface (UI) control component 502, an authentication component 503, a device connecting component 504, a network control component 505, a job execution management component 506, and a job control component 507. The job control component 507 includes a scan processing component 511, a copy processing component 512, a print processing component 513, and a facsimile processing component 514.

The UI control component 502 receives the job setting information or the like inputted by the user via the operation unit 307, and passes the job setting information to the job execution management component 506 or the job control component 507. Moreover, the UI control component 502 receives a response from the job execution management component 506 or the job control component 507, and outputs a screen based on the response to the operation unit 307.

The authentication component 503 performs the login processing based on the authentication information received from the information processing apparatus 101, and sends back a result of the login processing. The device connecting component 504 establishes, for example, wireless LAN communication with the information processing apparatus 101. The network control component 505 receives the job information including the job setting information, the job execution instruction command, the image data, the user authentication information, and the like from the information processing apparatus 101 via the network 103. The network control component 505 transmits the job setting information stored in the image forming apparatus 104 to the information processing apparatus 101 via the network 103.

The job execution management component 506 manages a state of the job to be executed and the like. Moreover, the job execution management component 506 stores the job information including the job setting information inputted by the user on the UI control component 502 and the job setting information received by the network control component 505 from the information processing apparatus 101, in the RAM 304 or the HDD 305. The job execution management component 506 may register these pieces of job setting information in “favorite” as settings frequently used by the user. Moreover, the job execution management component 506 may manage a custom job setting stored in the RAM 304 or the HDD 305 in installing of the application as “preset”. Moreover, the job execution management component 506 can manage the job executed in the image forming apparatus 104 as “history”.

The job control component 507 executes various jobs by controlling the processing components that are the scan processing component 511, the copy processing component 512, the print processing component 513, and the facsimile processing component 514 depending on the received job information. For example, the job control component 507 executes the various jobs by using the job setting information set by the user on the operation unit 307 or the job setting information in the “favorite” or the “preset” registered in the job execution management component 506. Moreover, the job control component 507 receives a job execution request including the job information and received from the information processing apparatus 101 or the like via the network 103, and executes various jobs based on the received job setting information and the job execution instruction. Furthermore, the job control component 507 transmits the job execution status and the operation state of the device of the scanner 313 or the printer 314 to the information processing apparatus 101 via the network 103.

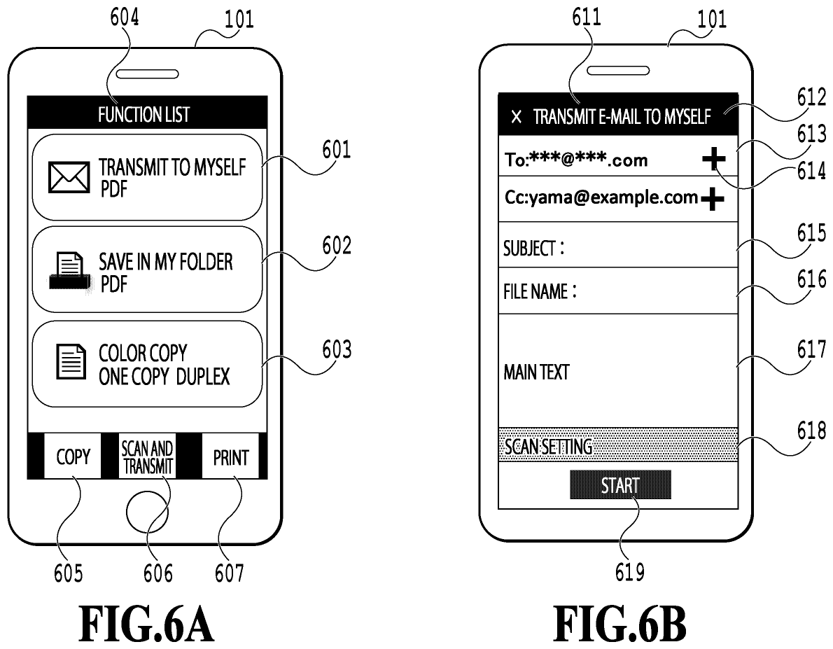

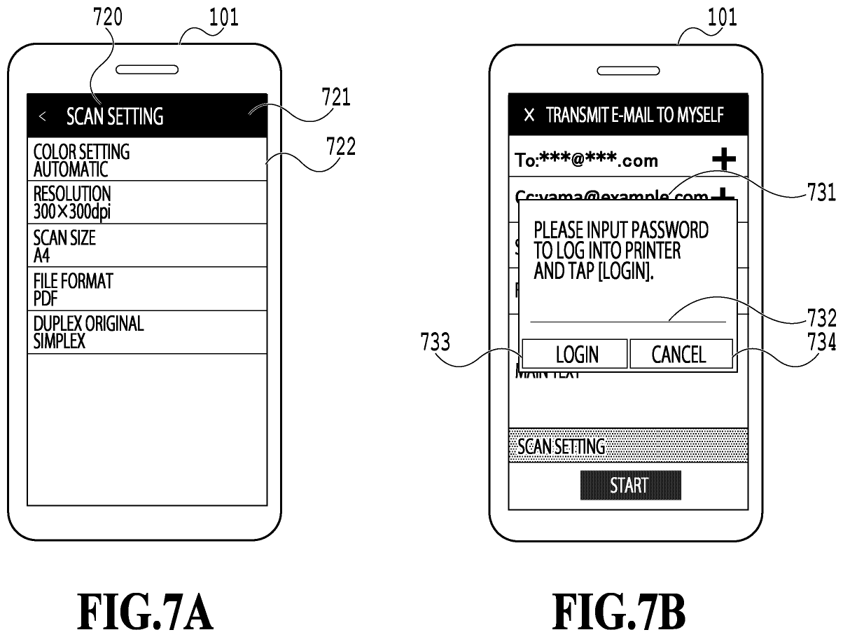

FIGS. 6A to 7B are diagrams illustrating display screens of the application 401 operating on the information processing apparatus 101. Processing of the application 401 performed on the information processing apparatus 101 is explained by using FIGS. 6A to 7B.

FIG. 6A is a menu screen of the application 401 operating on the information processing apparatus 101. The application 401 can communicate with the image forming apparatus 104, and give a processing execution instruction to the image forming apparatus 104 by using contents of setting performed on the application. Note that, at a moment before display of the menu screen of FIG. 6A, the information processing apparatus 101 is in a state where communication with the image forming apparatus 104 has been already established based on the obtained connection information. Moreover, in the case where the information processing apparatus 101 can communicate with multiple image forming apparatuses 104, the information processing apparatus 101 is in a state where a specific image forming apparatus 104 is selected. Specifically, in the case where the menu screen of FIG. 6A is displayed, the information processing apparatus 101 is in a state where the image forming apparatus 104 being a transmission destination of the instruction is specified.

The UI control component 402 displays a list (function list) of processes that use the functions of the image forming apparatus 104, on a menu screen 604 of the application 401. The function list displayed herein is such that, for example, regions (buttons) corresponding to the information registered as “favorite” or “preset” described above are displayed as a list. As an example, a “transmit to myself” button 601 that causes the image scanned by the image forming apparatus 104 to be transmitted to the user himself/herself (user logging in the image forming apparatus) by e-mail is displayed. Part of setting information is displayed in the “transmit to myself” button 601. Specifically, setting information indicating that a file format is PDF is displayed. Moreover, a “save in my folder” button 602 that causes the scanned image scanned by the image forming apparatus 104 to be saved in a registered folder of the user is displayed in the list. Furthermore, a “color copy” button 603 for performing duplex color copy for one copy in the image forming apparatus 104 is displayed in the list. Part of setting information is displayed also in these buttons.

In the case where the user presses the “transmit to myself” button 601, the screen transitions to a setting screen (FIG. 6B) for transmitting an e-mail to the user himself/herself Note that, in the present specification, pressing is used as a term including touching via the touch panel 215. In the case where the user presses the “save in my folder” button 602, the screen transitions to a setting screen (not illustrated) for saving the image in my folder. In the case where the user presses the “color copy” button 603, a setting screen (not illustrated) of the copy function is opened with setting values set to registered setting values.

A“copy” button 605 is a button for transmitting copy job information to the image forming apparatus 104. In the case where the “copy” button 605 is pressed, a setting screen (not illustrated) of the copy function is opened with setting values set to default setting values. A “scan and transmit” button 606 is a button for transmitting scan and transmit job information to the image forming apparatus 104. In the case where the “scan and transmit” button 606 is pressed, a setting screen for a scan and transmit function is opened with setting values set to default setting values. A “print” button 607 is a button for transmitting the print job information to the image forming apparatus 104. In the case where the “print” button 607 is pressed, a setting screen of the print function is opened with setting values set to default setting values.

FIG. 6B is the setting screen for the scan and transmit function. FIG. 6B is a screen displayed in the case where the user presses the “transmit to myself” button 601. Note that the “transmit to myself” function is one type of the “scan and transmit” function, and a mail address of the user himself/herself is assumed to be set in an address as a default value. Accordingly, FIG. 6B is also an example of the setting screen in the case where the “scan and transmit” button 606 is pressed.

A “scan and transmit” setting screen 611 is a screen in which setting for transmitting the scanned image by e-mail is performed. A title (“transmit to myself” in the present example) describing the setting screen is displayed in a title region 612, and a button for cancelling the setting and returning to the menu screen is also arranged in the title region 612. A mail address setting region 613 is a region in which a set mail address is displayed. In the case where this region is pressed, the user can directly input a mail address of the transmission destination by using a software keyboard. In the case where an address book activation button 614 is pressed, an address book in the information processing apparatus 101 is invoked. In the case where selection of the mail address from the invoked address book by the user is received, the selected mail address is displayed in the mail address setting region 613. Multiple mail addresses may be set.

A subject field 615 in which a subject is inputted, a file name input field 616, and a main text field 617 in which a main text is inputted can receive input of any character strings inputted by the user by using the software keyboard of the information processing apparatus 101. A start button 619 is a button for transmitting the job information to the image forming apparatus 104. Note that, in the case where the start button 619 is pressed, the application 401 may transmit the job information to the image forming apparatus 104 after getting confirmation from the user on whether the set mail address is the address intended by the user.

A scan setting button 618 is a button for performing scan setting. In the case where the scan setting button 618 is pressed, the screen transitions to a scan setting screen 720 illustrated in FIG. 7A. In the scan setting screen 720, a title is displayed in a title region 721, and a button for finalizing the setting and returning to the “scan and transmit” setting screen 611 is arranged in the title region 721. The scan setting screen 720 includes various buttons (for example, a color setting button 722) relating to scanning. In the case where the user presses each of the buttons, the user can perform corresponding setting. For example, in the case where the color setting button 722 is pressed, the screen transitions to a color setting screen (not illustrated) in which color setting can be changed, and the color setting set in the color setting screen is displayed on the corresponding button.

FIG. 7B is a screen displayed by the application 401 in the case where the application 401 needs to request the user for the authentication information in the transmission of the job information to the image forming apparatus 104 by the application 401. The user inputs a password into a password input region 732. Then, in the case where the user presses a login button 733, the authentication information inputted into the password input region 732 is transmitted to the image forming apparatus 104. In the case where a cancel button 734 is pressed, the authentication information request screen 631 is closed, and the screen returns to the “scan and transmit” setting screen 611.

Note that, as described above, the application 401 manages the authentication information inputted (registered) by the user in the authentication information management component 403. FIG. 7B is a screen displayed in the case where the authentication information is not managed in the authentication information management component 403 under a specific condition. Specifically, FIG. 7B is displayed in the case where the platform of the image forming apparatus 104 is the second platform on which the application 401 cannot be made to obtain the authentication necessary-unnecessary information, and in addition, the authentication information for the second platform is not managed (saved) in the application 401. Details are described later. Note that a screen different from FIG. 7B is displayed in the following case. Specifically, this case is a case where the platform of the image forming apparatus 104 is the first platform on which the application 401 can be made to obtain the authentication necessary-unnecessary information, and in addition, the authentication information for the first platform is not managed (saved) in the application 401. In this case, a different screen to be described later is displayed. Allowing the application 401 to obtain the authentication necessary-unnecessary information corresponds specifically to allowing the information processing apparatus 101 including the application 401 to obtain the authentication necessary-unnecessary information. Moreover, allowing the information processing apparatus 101 to obtain the authentication necessary-unnecessary information corresponds to transmitting the authentication necessary-unnecessary information to the information processing apparatus 101.

Although the examples of the menu screen and the scan and transmit (transmit to myself) screen are illustrated in FIGS. 6A to 7B, the present embodiment is not limited to these examples. Moreover, the setting screens of the respective functions are not limited to the illustrated examples.

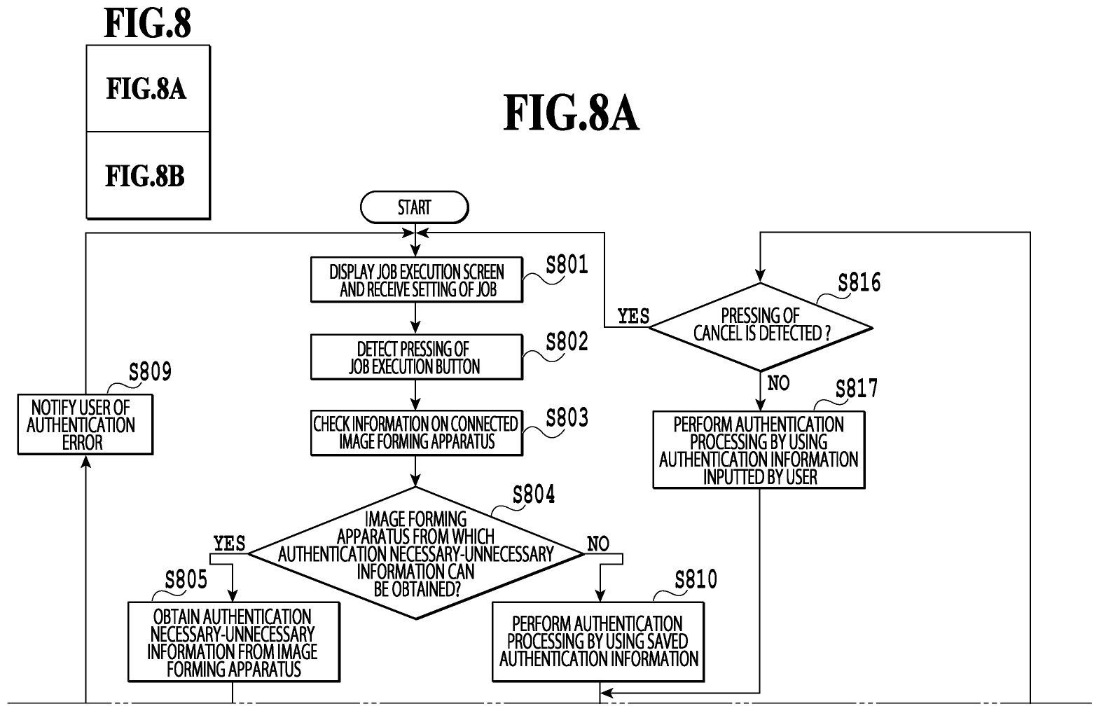

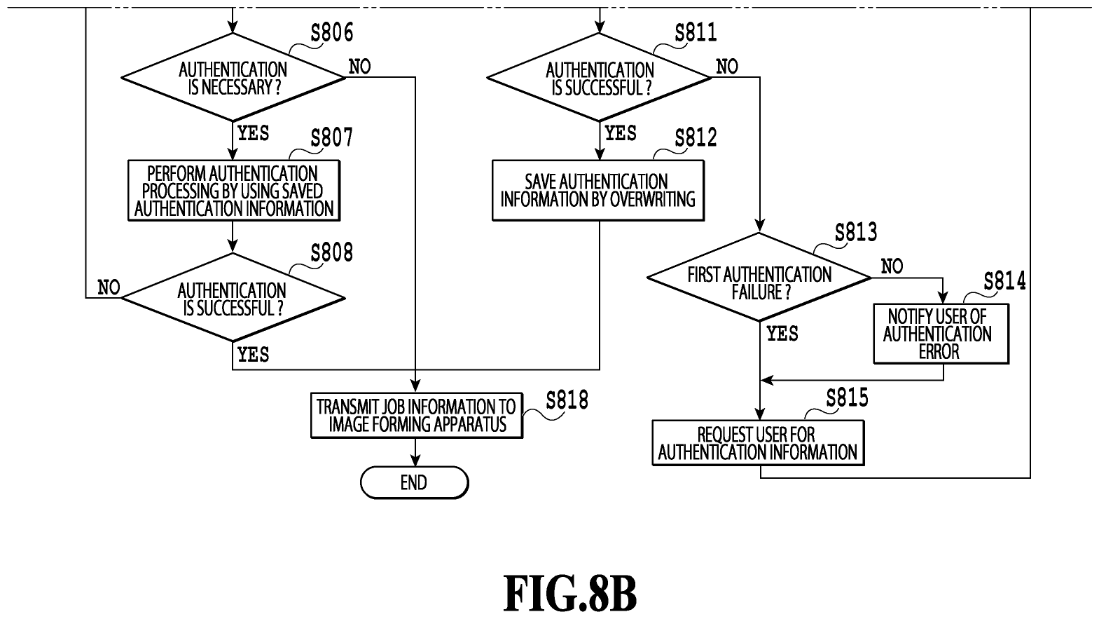

FIGS. 8A and 8B are totally a flowchart illustrating an example of control processing relating to authentication in the case where the information processing apparatus 101 transmits the job information to the image forming apparatus 104. The CPU 202 of the information processing apparatus 101 implements the processing illustrated in FIGS. 8A and 8B by functioning as the functional components illustrated in FIG. 4 as described above. Specifically, the CPU 202 implements the flowchart of FIGS. 8A and 8B by reading a program stored in the ROM 203, the storage device 209, or the like out to the RAM 204 and executing the program. Note that all or part of functions of the steps in FIGS. 8A and 8B may be implemented by hardware such as an ASIC or an electronic circuit. The sign S in explanation of each process means step in the flowchart (the same applies to the flowcharts in the present specification hereafter). Specifically, the CPU 202 implements each of the operations illustrated in the flowchart of FIGS. 8A and 8B by executing the application 401. Start of the processing illustrated in FIGS. 8A and 8B is triggered by, for example, pressing of a button of a predetermined function in the menu screen 604 illustrated in FIG. 6A.

Specifically, at a moment of start of the flowchart of FIGS. 8A and 8B, the image forming apparatus 104 to be the transmission destination of the job information is specified, and the information processing apparatus 101 and the image forming apparatus 104 are in a state where wireless communication therebetween is established. Moreover, in the present embodiment, explanation is given by using, as an example, a form in which the “scan and transmit” button 606 is selected by the user from the menu screen 604 of the information processing apparatus 101 and the “scan and transmit” job information is transmitted. Note that the function is not limited to the “scan and transmit” function, and the present embodiment may also be achieved in a form in which the job information of other jobs such as the FAX job or the print job is transmitted. Moreover, in the present flowchart, it is assumed that the user transmits the job information from the information processing apparatus 101 to the image forming apparatus 104 in a state where the user has not logged into the image forming apparatus.

In S801, the UI control component 402 displays a job execution screen, and receives a setting of job. For example, the UI control component 402 displays the “scan and transmit” setting screen 611 of FIG. 6B or the scan setting screen 720 of FIG. 7A, and receives the setting of job from the user. Next, in S802, the UI control component 402 receives pressing of the start button 619 by the user. The UI control component 402 is assumed to receive various settings in S801 until it detects pressing of the start button 619 by the user.

Next, in S803, the job control component 407 checks information on the image forming apparatus 104 connected via the device connecting component 404. In the present example, the information on the image forming apparatus 104 is a platform name of a firmware controller (firm controller) of the image forming apparatus 104. Moreover, the information on the image forming apparatus 104 is information obtained in the case where the information processing apparatus 101 and the image forming apparatus 104 are connected to each other via the device connecting component 404.

Next, in S804, the job control component 407 determines whether or not the information on whether the authentication is necessary or unnecessary (referred to as authentication necessary-unnecessary information) can be obtained from the connected image forming apparatus 104, based on the information on the image forming apparatus 104 checked in S803. In the case where the job control component 407 determines that the authentication necessary-unnecessary information can obtained, the job control component 407 proceeds to S805. If not, the job control component 407 proceeds to S810. In the present example, determination of whether or not the authentication necessary-unnecessary information can be obtained from the image forming apparatus 104 is performed based on the platform name of the firm controller checked in S803.

Image forming apparatuses vary in cost and installed functions depending on used locations and applications. The platforms of the firm controllers installed in the image forming apparatuses also vary depending on functional and cost constraints. For example, a large image forming apparatus that can also handle the A3 sheet size and a small image forming apparatus that cannot handle the A3 sheet size and can only handle sheet sizes up to the A4 sheet size vary in the platform of the firm controller in many cases. The platform of the firm controller installed in the image forming apparatus that can only handle sheet sizes up to the A4 sheet size has more performance constraints than the image forming apparatus that can also handle the A3 sheet size. Specifically, there are constraints in terms of usable functions and performances of hardware such as the RAM or the ROM from the viewpoint of cost. Accordingly, there are also differences in performance of an application program interface (API) held by each image forming apparatus. As one of these differences, there is a difference in whether or not the authentication necessary-unnecessary information can be obtained. Specifically, in the present embodiment, there is an image forming apparatus 104 of an apparatus model that can transmit the authentication necessary-unnecessary information to the information processing apparatus 101 (that can allow the information processing apparatus 101 to obtain the authentication necessary-unnecessary information). Moreover, in the present embodiment, there is assumed to be an image forming apparatus 104 of an apparatus model that cannot transmit the authentication necessary-unnecessary information to the information processing apparatus 101 (that cannot allow the information processing apparatus 101 to obtain the authentication necessary-unnecessary information). The platform names of the firm controllers included in the respective apparatus models are assumed to be different. Accordingly, the job control component 407 can determine whether or not the authentication necessary-unnecessary information can be obtained from the image forming apparatus 104 by referring to the platform name of the firm controller. As described above, an image forming apparatus with the first platform that can allow the information processing apparatus 101 to obtain the authentication necessary-unnecessary information is referred to as first image forming apparatus. The first platform that can allow the information processing apparatus 101 to obtain the authentication necessary-unnecessary information is, in other words, the first platform that can provide the authentication necessary-unnecessary information to the information processing apparatus 101. An image forming apparatus with the second platform that cannot allow the information processing apparatus 101 to obtain the authentication necessary-unnecessary information is referred to as second image forming apparatus. The second platform that cannot allow the information processing apparatus 101 to obtain the authentication necessary-unnecessary information is, in other words, the second platform that cannot provide the authentication necessary-unnecessary information to the information processing apparatus 101.

Specifically, the large image processing apparatus that can also handle the A3 sheet size is an apparatus model that can transmit the authentication necessary-unnecessary information to the information processing apparatus 101. The small image forming apparatus that cannot handle the A3 sheet size and can only handle sheet sizes up to the A4 sheet size is an apparatus model that cannot transmit the authentication necessary-unnecessary information to the information processing apparatus 101.

Accordingly, in the determination in S804, in the case where the information on the image forming apparatus 104 checked in S803 includes the platform name of the firm controller included in the apparatus model that can transmit the authentication necessary-unnecessary information to the information processing apparatus 101, the job control component 407 determines YES. In the case where the information on the image forming apparatus 104 checked in S803 includes the platform name of the firm controller included in the apparatus model that cannot transmit the authentication necessary-unnecessary information to the information processing apparatus 101, the job control component 407 determines NO.

Note that, for example, the application 401 is assumed to have information for identifying which platform name is the first platform and which platform name is the second platform, in a table format. Accordingly, the determination of S804 is assumed to be executed based on the information obtained from the image forming apparatus 104 and the information that is not obtained from the image forming apparatus 104 and that is held by the application 401 in advance. Note that the platform name is merely an example, and the determination of S804 does not have to be based on the platform name. Any apparatus model information by which the type of the apparatus can be identified can be used. In other words, the platform name of the firm controller or information other than the platform name may be referred to as the apparatus model information. Specifically, an apparatus model name of the image forming apparatus 104 may be referred to. In this form, for example, there are assumed to be an apparatus model corresponding to the first platform and an apparatus model corresponding to the second platform. Whether the apparatus model name of the image forming apparatus 104 is the apparatus model name corresponding to the first platform or the apparatus model name corresponding to the second platform is assumed to be determined in S804. Specifically, in the case where the information on the image forming apparatus 104 checked in S803 includes the apparatus model name of the apparatus model that can transmit the authentication necessary-unnecessary information to the information processing apparatus 101, the job control component 407 determines YES. In the case where the information on the image forming apparatus 104 checked in S803 includes the apparatus model name of the apparatus model that cannot transmit the authentication necessary-unnecessary information to the information processing apparatus 101, the job control component 407 determines NO. For example, there are multiple apparatus model names of apparatus models that use the first platform. In other words, processing using the apparatus model name indicating a smaller range than the platform name may be performed. Note that, for example, a serial number of the image forming apparatus 104, capability information of the image forming apparatus 104, and the like may be used for the determination of S804, in addition to the apparatus model name.

Returning to FIG. 8B, explanation is given of the case where the image forming apparatus 104 has the first platform that can allow the information processing apparatus 101 to obtain the authentication necessary-unnecessary information. In S805, the job control component 407 obtains the authentication necessary-unnecessary information from the image forming apparatus 104. In S806, the job control component 407 determines whether or not the authentication necessary-unnecessary information obtained in S805 indicates that the authentication is necessary. In the case where the authentication necessary-unnecessary information indicates that the authentication is necessary, the job control component 407 proceeds to S807. If not, the job control component 407 proceeds to S818.

In S807, the job control component 407 transmits the authentication information managed by (saved in) the authentication information management component 403 to the image forming apparatus 104, and performs authentication processing. As described above, in the authentication information management component 403 of the application 401, the authentication information for the first platform and the authentication information for the second platform are separately managed. In S807, the job control component 407 performs the authentication processing by using the authentication information for the first platform. Next, in S808, the job control component 407 determines whether or not the authentication processing performed in S807 is successful. In the case where the authentication is successful, the job control component 407 proceeds to S818. In the case where the authentication fails, the job control component 407 proceeds to S809.

In S809, the UI control component 402 notifies the user of an authentication error indicating failure of authentication. Specifically, in the case where the authentication is necessary for the image forming apparatus 104 in the transmission of the job information and this authentication fails, the user is notified of an authentication error.

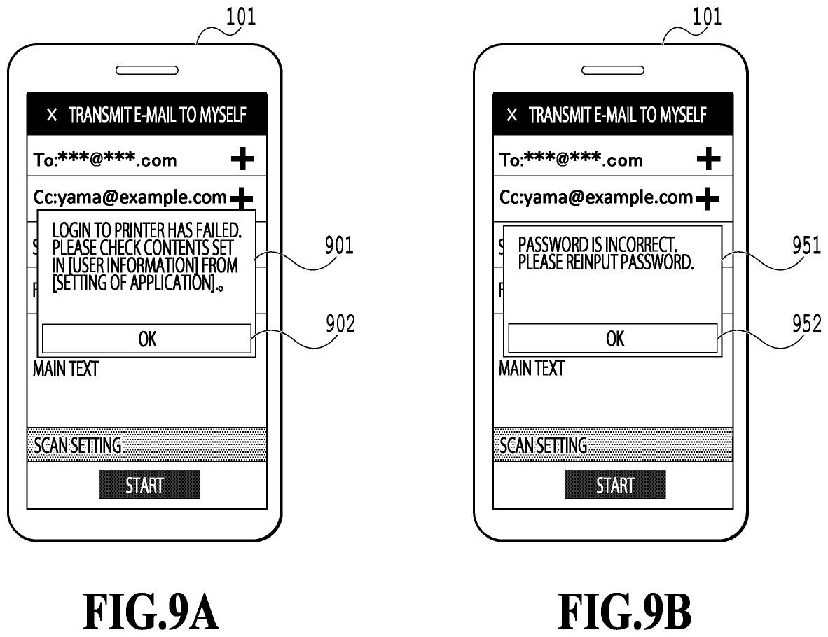

FIGS. 9A and 9B are diagrams illustrating display screens of the application 401 operating on the information processing apparatus 101. FIG. 9 Ais a diagram illustrating an example of an error screen in the notification of S809. In the case where the authentication fails, a message 901 prompting check of the saved authentication information is displayed. In the case where an OK button 902 is pressed, the job control component 407 returns to S801, and the screen transitions to the job execution screen. Note that the case where the authentication information for the first platform is not saved in the authentication information management component 403 is also handled as authentication failure, and the user is similarly notified of the authentication error in S809. As described above, the authentication information for the first platform can be set by the user on the application 401. Accordingly, in FIG. 9A, a message instructing to check the contents set in the user information set in the application 401 is displayed.

Next, explanation is given of the case where the image forming apparatus 104 has the second platform on which the authentication necessary-unnecessary information cannot be obtained. In S810, the job control component 407 transmits the authentication information saved in the authentication information management component 403 to the image forming apparatus 104, and attempts to perform the authentication processing. As described above, the authentication information for the second platform is not set by the user operation via the touch panel 215 or the like, but is set and managed inside the application 401. In initial processing, the authentication information for the second platform is in a state where it is not saved in the authentication information management component 403.

This authentication processing attempted by the job control component 407 in S810 is processing performed to check whether or not the authentication is set to be necessary in the image forming apparatus 104. Specifically, since the authentication necessary-unnecessary information cannot be obtained from the image forming apparatus 104 being the transmission destination, whether or not the authentication is necessary for the image forming apparatus 104 is unknown. Accordingly, first, in order to check whether the authentication is necessary or unnecessary, the job control component 407 attempts to perform the authentication processing by using the authentication information for the second platform saved in the authentication information management component 403. Note that, in the case where no authentication information for the second platform is saved in the authentication information management component 403, the job control component 407 transmits empty authentication information.

In S811, the job control component 407 determines whether or not the authentication processing performed in S810 is successful. In the case where the authentication is successful, the job control component 407 proceeds to S812. In the case where the authentication fails, the job control component 407 proceeds to S813. In the case where the authentication is set to be unnecessary in the image forming apparatus 104, the authentication is successful regardless of the type of authentication information transmitted.

In S812, the job control component 407 saves the authentication information used in the successful authentication, in the authentication information management component 403 by overwriting. Then, the job control component 407 proceeds to S818. As described above, the authentication information for the second platform is configured to be saved by the internal processing of the application 401. Accordingly, there is performed processing of saving the authentication information for the second platform used in the successful authentication by overwriting the authentication information for the second platform saved in the authentication information management component 403 with the authentication information for the second platform used in the successful authentication. If the empty authentication information is transmitted in S810, the empty authentication information is saved by overwriting.

There are two cases where the job control component 407 proceeds to S812. A first case is a case where the authentication is set to be unnecessary in the image forming apparatus 104. In this case, the authentication is successful regardless of the type of authentication information transmitted, as described above. A second case is a case where the authentication is set to be necessary in the image forming apparatus 104 and the correct authentication information is transmitted. As described above, the case where the job control component 407 proceeds to S812 includes the case where the authentication processing is performed again on the image forming apparatus 104 determined to be the image forming apparatus 104 for which the authentication is necessary, and is successful. In the second case, the successful authentication information (authentication information that is not empty) is saved as the authentication information for the second platform in the authentication information management component 403 by overwriting.

In S813, the job control component 407 determines whether or not the authentication failure is the first failure. In the case of the first authentication failure, the job control component 407 proceeds to S815. In the case of the second authentication failure or beyond, the job control component 407 proceeds to S814. The case of the first failure is the case where the image forming apparatus 104 being the transmission destination is presumed to be the image forming apparatus for which the authentication is necessary. If the user is notified of the authentication error in the first failure corresponding to, so to say, temporary authentication processing as described above, the user may be confused. Accordingly, in the first failure, a process of notifying the user of the authentication error (process of S814) is skipped. Meanwhile, since the case of the second failure and beyond can be presumed to be the case where the authentication information inputted by the user is incorrect or the like, the process of notifying the user of the authentication error is performed as described below.

In S814, the UI control component 402 notifies the user of the failure of the authentication. FIG. 9B illustrates an example of a notification screen displayed in the application 401 in S814. In FIG. 9B, a message 951 noting that the authentication information is incorrect is displayed. In the case where an OK button 952 is pressed, the job control component 407 proceeds to S815.

In S815, the UI control component 402 displays the screen of FIG. 7B, and requests the user for the authentication information. Then, the job control component 407 proceeds to S816.

In S816, the UI control component 402 determines whether or not pressing of the cancel button 734 by the user is detected. In the case where the pressing of the cancel button 734 is detected, the job control component 407 returns to S801. If not, the job control component 407 proceeds to S817.

In S817, the job control component 407 transmits the authentication information inputted by the user to the image forming apparatus 104, and performs the authentication processing. Then, the job control component 407 proceeds to S811, and determines whether or not the authentication is successful as described above.

In S818, the job control component 407 transmits the job information to the image forming apparatus 104. In the case where the authentication is determined to be necessary, the transmitted job information includes the authentication information.

Note that, in the above example, explanation is given by using, as an example, the form in which the job information is transmitted from the information processing apparatus 101 to the image forming apparatus 104 in the state where the user has not logged into the image forming apparatus 104. There is a case where the user has logged into the image forming apparatus 104 before the transmission of the job information. Specifically, there is a case where the user has inputted the authentication information by using the operation unit 307 of the image forming apparatus 104 or the like, and has already logged into the image forming apparatus 104. Explanation is given below of processing in the case where the user has already logged into the image forming apparatus 104. The processing varies depending on whether the image forming apparatus is the first image forming apparatus with the first platform or the second image forming apparatus with the second platform.

In the case where the image forming apparatus is the first image forming apparatus (specifically, in the case of YES in S804 of FIG. 8A), the authentication is successful in S808 if the same authentication information is managed in the authentication information management component 403, and the job information is transmitted in S818. If the authentication information different from the authentication information used in the already-performed login is managed in the authentication information management component 403, the authentication fails in S808, and the error notification of S809 is performed.

Meanwhile, in the case where the image forming apparatus is the second platform (specifically, in the case of NO in S804 of FIG. 8A), the application 401 displays an error message noting that the function cannot be used because the image forming apparatus main body is in the logged-in state. Then, the application 401 returns to the job execution screen. This is because an authentication method of logging into the image forming apparatus main body and the authentication method on the second platform are different. In this case, the user logs out from the image forming apparatus (second image forming apparatus), and then gives an instruction to execute the job again through the application 401. This may allow the job information to be eventually transmitted to the second image forming apparatus according to the processing of FIGS. 8A and 8B.

As explained above, according to the present embodiment, the processing can be appropriately switched depending on whether the authentication is necessary or unnecessary in the image forming apparatus. Specifically, also in the case where the information processing apparatus 101 cannot obtain the information on whether the authentication is necessary or unnecessary from the image forming apparatus 104, the processing of the information processing apparatus 101 can be switched depending on whether the authentication is necessary or unnecessary. In other words, in the present embodiment, it is possible to switch between job transmission performed without execution of the authentication processing and job transmission performed with the authentication processing executed, depending on the setting of whether the authentication is necessary or unnecessary on the image forming apparatus side, irrespective of whether or not the authentication necessary-unnecessary information is obtained.

### Second Embodiment

In the first embodiment, explanation is given of the example in which, if the authentication is successful in S811 in the case where the image forming apparatus of the second platform is the transmission target, in S812, the authentication information for the second platform is saved in the authentication information management component 403 by overwriting. The configuration in which the authentication information is saved by overwriting uniformly for all cases as described above is a configuration in which implementation of the application 401 is facilitated in terms of design. However, since this processing is processing of saving the authentication information in the authentication information management component 403 by overwriting also in the case where the application 401 succeeds in the authentication by using the authentication information saved in the authentication information management component 403, this state can be said as a state where unnecessary processing is generated.

Accordingly, in the present embodiment, explanation is given of an example in which the authentication information for the second platform is saved by overwriting only if the authentication fails in the case where the image forming apparatus of the second platform is the transmission target. Since a basic configuration of the present embodiment is the same as that in the example explained in the first embodiment, differences are mainly explained.

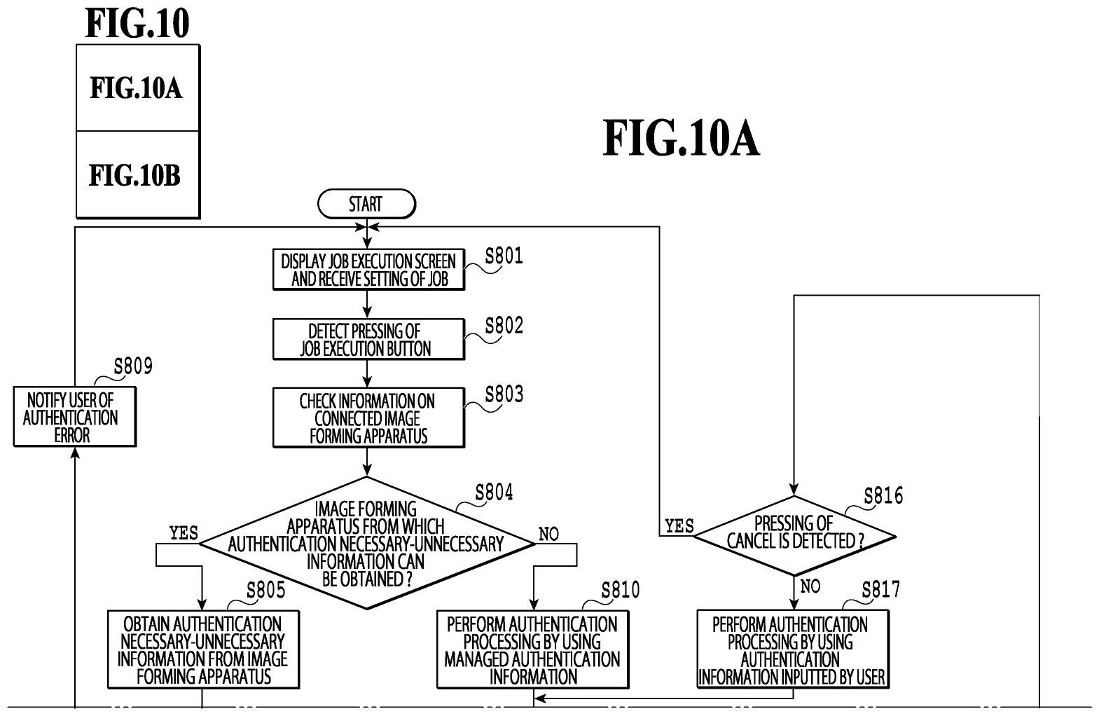

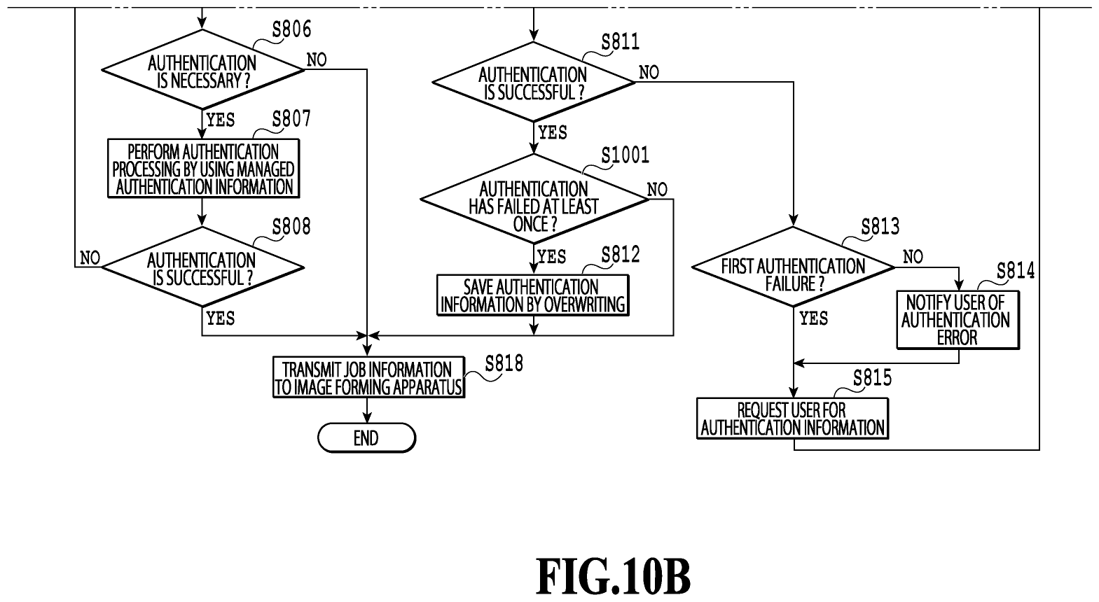

FIGS. 10A and 10B are totally a flowchart illustrating an example of control processing relating to the authentication in the case where the information processing apparatus 101 transmits the job information to the image forming apparatus 104. As in the example explained in the first embodiment, the CPU 202 of the information processing apparatus 101 implements the processing illustrated in FIGS. 10A and 10B by functioning as the functional units illustrated in FIG. 2 as described above. Moreover, a trigger of start of the processing in FIGS. 10A and 10B is also the same as that in the example explained in the first embodiment.

Processes in FIGS. 10A and 10B that are the same as the processes illustrated in FIGS. 8A and 8B are denoted by the same reference numerals as in FIGS. 8A and 8B, and explanation thereof is omitted. In the present embodiment, after the authentication is determined to be successful in S811, the job control component 407 proceeds to S1001. In S1001, the job control component 407 determines whether the authentication has failed at least once. In the case where the job control component 407 determines that the authentication has failed at least once, the job control component 407 proceeds to S812. In the case where the authentication has not failed even once, the job control component 407 proceeds to S818.

As explained above, in the present embodiment, the processing of saving the authentication information in the authentication information management component 403 by overwriting is performed only in the case where the application 401 succeeds in the authentication by using the saved authentication information for the second platform and has failed in the authentication at least once. The processing can be thereby switched depending on the setting on whether the authentication is necessary or unnecessary on the image forming apparatus side, irrespective of whether the authentication necessary-unnecessary information is obtained or not, while omitting the unnecessary step.

### Other Embodiments

In the above-mentioned embodiments, the example in which the authentication information for the first platform and the authentication information for the second platform are managed is explained. In the case where the image forming apparatus 104 being the transmission destination of the job information is changed to another image forming apparatus, the processing illustrated in FIGS. 8A, 8B, 10A or 10B described above is performed, and the authentication information is saved by overwriting in a procedure of this processing. Note that this example is merely an example, and the configuration may be such that the authentication information management component 403 manages the authentication information for each of the image forming apparatuses, and processing using the authentication information for each image forming apparatus is performed.

Moreover, it only necessary that the authentication information is managed by the authentication information management component 403, and the authentication information does not have to be stored in a storage device or the like in the information processing apparatus 101. For example, the configuration may be such that actual data is saved in an external server, and the authentication information management component 403 reads the externally-saved authentication information.

Moreover, explanation is given of the example in which, in the case where the image forming apparatus of the second platform that cannot allow obtaining of the authentication necessary-unnecessary information is the transmission target, the empty authentication information is transmitted once to determine whether or not the image forming apparatus is the image forming apparatus for which the authentication processing is necessary. In this case, the authentication information used in the first attempt is not limited to the empty authentication information. Information that cannot be used (specifically not used) in the authentication in the image forming apparatus may be used instead of the empty authentication information.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-150944, filed Sep. 19, 2023, which is hereby incorporated by reference wherein in its entirety.

What is claimed is:

1. A control method of an information processing apparatus, comprising
checking information on an apparatus model of a communication apparatus that is a transmission destination of a job;
determining whether or not predetermined authentication relating to the job to be transmitted to the communication apparatus is necessary for the communication apparatus, based on a case where the information on the apparatus model of the communication apparatus is checked to be information corresponding to a first apparatus model;
executing processing for the predetermined authentication based on a case where the predetermined authentication is determined to be necessary for the communication apparatus;
executing the processing for the predetermined authentication irrespective of whether or not the predetermined authentication is necessary for the communication apparatus, based on a case where the information on the apparatus model of the communication apparatus is checked to be information corresponding to a second apparatus model different from the first apparatus model; and
transmitting the job to the communication apparatus.

2. The control method according to claim 1, further comprising obtaining authentication necessary-unnecessary information from the communication apparatus, the authentication necessary-unnecessary information indicating whether or not the predetermined authentication relating to the job to be transmitted to the communication apparatus is necessary for the communication apparatus, wherein
the determining whether or not the predetermined authentication relating to the job to be transmitted to the communication apparatus is necessary for the communication apparatus is executed based on the authentication necessary-unnecessary information.

3. The control method according to claim 2, wherein the authentication necessary-unnecessary information is obtained based on the case where the information on the apparatus model of the communication apparatus is checked to be the information corresponding to the first apparatus model.

4. The control method according to claim 2, wherein the authentication necessary-unnecessary information is not obtained in the case where the information on the apparatus model of the communication apparatus is checked to be the information corresponding to the second apparatus model.

5. The control method according to claim 2, wherein
the communication apparatus that is the first apparatus model is an apparatus of an apparatus model that is capable of allowing the information processing apparatus to obtain the authentication necessary-unnecessary information, and
the communication apparatus that is the second apparatus model is an apparatus of an apparatus model that is not capable of allowing the information processing apparatus to obtain the authentication necessary-unnecessary information.

6. The control method according to claim 1, wherein the processing for the predetermined authentication includes processing of transmitting authentication information to the communication apparatus, the authentication information saved in a region managed by a predetermined application program that executes the processing for the predetermined authentication.

7. The control method according to claim 6, wherein the processing for the predetermined authentication includes processing of transmitting predetermined authentication information to the communication apparatus even in a case where the authentication information saved in the region managed by the predetermined application program is absent.

8. The control method according to claim 7, further comprising:
displaying an input screen that receives input of the authentication information from a user in a case where the predetermined authentication fails as a result of transmission of the predetermined authentication information to the communication apparatus in a state where the predetermined authentication is necessary for the communication apparatus; and
executing the processing for the predetermined authentication again by using the authentication information inputted in the input screen.

9. The control method according to claim 8, further comprising notifying the user of failure of the predetermined authentication in a case where the predetermined authentication fails despite execution of the processing for the predetermined authentication performed by using the authentication information inputted in the input screen.

10. The control method according to claim 8, further comprising saving the authentication information inputted in the input screen in the region managed by the predetermined application program in a case where the predetermined authentication is successful as a result of execution of the processing for the predetermined authentication performed by using the authentication information inputted in the input screen.

11. The control method according to claim 1, wherein, in the case where the information on the apparatus model of the communication apparatus is the information corresponding to the second apparatus model and the predetermined authentication is unnecessary for the communication apparatus, the predetermined authentication is successful regardless of which authentication information is transmitted to the communication apparatus in the processing for the predetermined authentication.

12. The control method according to claim 1, wherein the job is transmitted to the communication apparatus based on success of the predetermined authentication.

13. The control method according to claim 1, wherein an input screen that receives input of authentication information from a user is not displayed based on failure of the predetermined authentication as a result of the processing for the predetermined authentication executed in the case where the information on the apparatus model of the communication apparatus is checked to be the information corresponding to the first apparatus model, and is displayed based on failure of the predetermined authentication as a result of the processing for the predetermined authentication executed in the case where the information on the apparatus model of the communication apparatus is checked to be the information corresponding to the second apparatus model.

14. The control method according to claim 13, further comprising notifying the user of the failure of the predetermined authentication based on the failure of the predetermined authentication as a result of the processing for the predetermined authentication executed in the case where the information on the apparatus model of the communication apparatus is checked to be the information corresponding to the first apparatus model.

15. The control method according to claim 1, wherein the information on the apparatus model of the communication apparatus is information indicating a platform of a firm controller of the communication apparatus.

16. The control method according to claim 1, wherein the first apparatus model and the second apparatus model vary in at least one of a platform of a firm controller of the communication apparatus, a sheet size handleable by the communication apparatus, a function usable by the communication apparatus, and an application program interface (API) held by the communication apparatus.

17. The control method according to claim 1, wherein the job is at least one of a scan job, a FAX job, and a print job.

18. The control method according to claim 1, wherein the job is a job for causing the communication apparatus to transmit an image, obtained by executing scanning with the communication apparatus, by e-mail.

19. An information processing apparatus comprising:
a first check unit configured to check information on an apparatus model of a communication apparatus that is a transmission destination of a job;
a determination unit configured to determine whether or not predetermined authentication relating to the job to be transmitted to the communication apparatus is necessary for the communication apparatus, based on a case where the information on the apparatus model of the communication apparatus is checked to be information corresponding to a first apparatus model;
a first execution unit configured to execute processing for the predetermined authentication based on a case where the predetermined authentication is determined to be necessary for the communication apparatus;
a second execution unit configured to execute the processing for the predetermined authentication irrespective of whether or not the predetermined authentication is necessary for the communication apparatus, based on a case where the information on the apparatus model of the communication apparatus is checked to be information corresponding to a second apparatus model different from the first apparatus model; and
a transmission unit configured to transmit the job to the communication apparatus.

20. A non-transitory computer readable storage medium storing a program which causes a computer to execute a control method of an information processing apparatus, the control method comprising:
checking information on an apparatus model of a communication apparatus that is a transmission destination of a job;
determining whether or not predetermined authentication relating to the job to be transmitted to the communication apparatus is necessary for the communication apparatus, based on a case where the information on the apparatus model of the communication apparatus is checked to be information corresponding to a first apparatus model;
executing processing for the predetermined authentication based on a case where the predetermined authentication is determined to be necessary for the communication apparatus;
executing the processing for the predetermined authentication irrespective of whether or not the predetermined authentication is necessary for the communication apparatus, based on a case where the information on the apparatus model of the communication apparatus is checked to be information corresponding to a second apparatus model different from the first apparatus model; and
transmitting the job to the communication apparatus.
